(19) United States
(12) Patent Application Publication
(10) Pub. No.: US 2013/0129119 A1
(43) Pub. Date: May 23, 2013

(54) MICROPHONE UNIT

(71) Applicants: Kenshou Miyatake, Osaka (JP); Ryusuke Horibe, Osaka (JP)

(72) Inventors: Kenshou Miyatake, Osaka (JP); Ryusuke Horibe, Osaka (JP)

(73) Assignee: FUNAI ELECTRIC CO., LTD., Osaka (JP)

(21) Appl. No.: 13/813,492

(22) PCT Filed: Jul. 15, 2011
(86) PCT No.: PCT/JP2011/066197

§ 371 Date: Jan. 31, 2013

(30) Foreign Application Priority Data
Aug. 5, 2010 (JP) 2010-175967

(51) Int. Cl. H04R 9/08

(52) U.S. Cl. CPC H04R 9/08
USPC 381/176

(57) ABSTRACT

A microphone unit (1) is provided with: a case (11), in which a diagram (contained in a MEMS chip (12)) that vibrates due to sound pressure, an internal space (111) that houses the diagram, and an opening (112) that links the internal space (111) to the outside and serves as a tone hole, are disposed; and a film (14) that is formed by a material that is not permeable to air, and that is joined to the base (11) in such a manner as to cover the opening (112). An internal pressure regulation section (141) is disposed in the film (14).

### TECHNICAL FIELD

The present invention relates to a microphone unit that includes a function to convert an input sound into an electric signal and output the electric signal.

### BACKGROUND ART

Conventionally, for example, a microphone unit, which has a function to convert an input sound into an electric signal and output it, is applied to: voice communication apparatuses such as a mobile phone, a transceiver and the like; information process systems such as a voice identification system and the like that use a technology for analyzing an input voice; or recording apparatuses and the like. Especially, in recent years, a microphone, which uses a MEMS (Micro Electro Mechanical System) technology for a vibration film (diaphragm), that is, a MEMS microphone (microphone unit) is rapidly becoming widespread. In a MEMS microphone, because a vibration film is formed of an inorganic material such as silicon or the like, the microphone has high heat resistance and reflow resistance, accordingly, its use is rapidly spreading especially to mobile apparatuses such as a mobile phone and the like.

In such a microphone unit, if dust invades from a sound hole into an inside, there is a case where an operation defect occurs. Because of this, it is desired that a microphone unit is formed such that dust does not invade into the inside or invades as little as possible during a transportation time, a process of mounting the microphone in a mount target (a substrate of a mobile phone and the like) and the like.

In this point, a patent document 1 discloses a microphone (microphone unit) that is able to prevent a liquid and a powder from invading into a sound hole. Specifically, a technology is disclosed, in which the sound hole of the microphone is covered by means of a nonwoven fabric that has air permeability such that a liquid and the like do not invade in the inside of the microphone via the sound hole. Besides, a technology is disclosed, in which the sound hole of the microphone is covered to have no gap by means of a film that has a sag or is embossed and has no air permeability such that a liquid and the like do not invade into the inside of the microphone via the sound hole.

### CITATION LIST

### Patent Literature

PLT1: JP-A-2010-11340

### SUMMARY OF INVENTION

### Technical Problem

However, in the case of the structure in which the sound hole is covered by means of the nonwoven fabric to prevent the dust invasion, there is a problem that a relatively large fiber-like dust occurring from a sectional surface (end surface) of the nonwoven fabric invades from the sound hole into the inside of the microphone. Besides, in the case of the structure in which the sound hole is covered by means of the film having not air permeability to prevent dust invasion, the following problem occurs in a case where a MEMS microphone is mounted in a mount target (a substrate of a mobile phone and the like).

In the case where a MEMS microphone is mounted in a mount target, it is usual that a reflow process is performed. In a case where a sound hole is completely sealed and covered by means of a film having no air permeability, during a temperature rise time in the reflow process (e.g., reflow temperatures of about 180 to about 260° C.), there is a case where the air in a space in the microphone expands and the internal pressure rises (e.g., about 1.8 fold); and the film having no air permeability, which is bonded and fixed to cover the sound hole, breaks. If the breakage of the film occurs, a problem occurs, in which the diaphragm is damaged by the impact and the operation defect occurs in the microphone; besides, a relatively large hole is formed and dust that invades into the inside of the microphone is so large that it damages the performance of the microphone.

Accordingly, it is an object of the present invention to provide a microphone unit that is able to prevent dust from invading during a transportation time, a mount process and the like and is unlikely to deteriorate in performance even if a reflow process is performed.

### Solution to Problem

To achieve the above object, a microphone unit according to the present invention includes: a diaphragm that is vibrated by a sound pressure; a housing that is provided with an internal space for housing the diaphragm and an opening portion that is used as a sound hole and makes the internal space communicate with outside; and a film that is formed of a material having no air permeability and bonded to the housing to cover the opening portion; wherein the film is provided with an internal pressure adjustment portion.

Here, the film is removed after the microphone unit is mounted in a mount target. Besides, it is preferable that the film formed of the material having no air permeability has heat resistance. Specifically, it is preferable that the film is resistant to temperatures of 180° C. or higher, further, resistant to temperatures of 260° C. or higher. As the heat resistant film having no air permeability, for example, a polyimide film is usable.

According to the present structure, the opening portion used as the sound hole is covered by means of the film that is composed of the material having no air permeability, accordingly, during a time of transporting the microphone unit, a process of mounting the microphone unit and the like, it is possible to prevent dust from invading into the inside of the microphone unit. Besides, during a time of attaching the film, dust does not invade unlike a case of a nonwoven fabric. Further, the film used for the prevention of dust invasion is provided with the internal pressure adjustment portion, accordingly, it is possible to prevent the film from breaking and damaging performance of the microphone unit during a reflow process.

In the microphone unit having the above structure, the film may be bonded to the housing by a first adhesive portion that is formed to surround the opening portion; and when viewing the microphone unit from a side on which the film is disposed, the internal pressure adjustment portion may be disposed at a more inner position than the first adhesive portion.

According to this structure, by applying simple forming to the film, it becomes possible to prevent dust from invading during the transportation time, the mount process and the like, and to provide the microphone unit that is unlikely deteriorate in performance even if the reflow process is performed.

In the microphone unit having the above structure, the internal pressure adjustment portion may be at least one internal pressure adjustment hole that penetrates the film. As for the through-hole for the internal pressure adjustment, its function is sufficiently obtainable even if the opening diameter is small, accordingly, even in the case where the hole is provided, it is possible to avoid a trouble that such a large dust (e.g., 100 μm or larger) invades and damages the performance of the microphone unit. In other words, the prevention function of dust invasion is sufficiently obtainable even in the present structure.

In the microphone unit having the above structure, when viewing the microphone unit from the side on which the film is disposed, the internal pressure adjustment hole may be disposed at a position that overlaps the opening portion, or may be disposed at a position that does not overlap the opening portion. According to the latter, in a case where the internal pressure of the microphone unit does not rise (inclusive of a pressure reduction time as well), it is possible to obtain a state where the internal pressure adjustment hole and the opening portion are shut off from each other and to lower the probability of dust invasion.

And, when viewing the microphone unit from the side on which the film is disposed, in the case where the internal pressure adjustment portion is disposed at the position that does not overlap the opening portion, the internal pressure adjustment hole may be disposed near the opening portion, or may be disposed at a more outer distant position than the opening portion.

According to the former structure, it is easy to obtain a structure in which the internal pressure adjustment hole and the opening portion communicate with each other when the internal pressure rises. Besides, according to the latter structure, the distance between the opening portion and the internal pressure adjustment hole becomes long, accordingly, it is possible to reduce the likelihood that dust invading from the internal pressure adjustment hole invades into the inside of the microphone unit.

And, in the latter structure, when viewing the microphone unit from the side on which the film is disposed, a second adhesive portion may be disposed to spread outward from a position more inner than the internal pressure adjustment hole between the opening portion and the first adhesive portion to surround the opening portion and bond the film and the housing to each other by means of an adhesive force weaker than the first adhesive portion. According to this structure, in principle, the housing and the film are bonded to each other by the second adhesive portion, accordingly, dust does not invade from the internal pressure adjustment hole into the inside of the microphone unit. On the other hand, in a case where the internal pressure rises during the reflow process, the bonding by the second adhesive portion having a weak adhesive force easily peels off thanks to the pressure, and it is possible to let air escape from the internal pressure adjustment hole, accordingly, it is possible to prevent the film breakage.

Besides, in the latter structure, when viewing the microphone unit from the side on which the film is disposed, the second adhesive portion may be disposed between the opening portion and the first adhesive portion to surround the opening portion except for one portion and bonds the film and the housing to each other, and the internal pressure adjustment hole may be disposed at a position that is situated between the first adhesive portion and the second adhesive portion and is away from the one portion. According to this structure, it is possible to lengthen the route length that extends from the internal pressure adjustment hole to the opening portion, and it is possible to reduce the likelihood that dust invading from the internal pressure adjustment hole invades into the inside of the microphone unit.

In the microphone unit having the above structure, the internal pressure adjustment portion may be a thin portion that changes into a minuscule through-hole in a case where a pressure acts on the film. According to the present structure, in principle, the film is not provided with a through-hole, accordingly, dust does not invade. Besides, because of the thinness, the thin portion of the film is able to easily change into the minuscule through-hole thanks to a rise of the internal pressure, accordingly, the thin portion is able to demonstrate the internal pressure adjustment function without giving a large impact to the inside of the microphone unit.

In the microphone unit having the above structure, one surface of the film may be provided with an adhesive layer that has a concave and convex shape, and a concave portion formed on the adhesive layer may function as the internal pressure adjustment portion. According to the present structure, without applying forming to the film itself, it becomes possible to provide the microphone unit that is able to prevent dust from invading during the transportation time, the mount process and the like and is unlikely to deteriorate in performance even if the reflow process is performed.

In the microphone unit having the above structure, a MEMS (Micro Electro Mechanical System) chip, which has the diaphragm and a fixed electrode that collaborates with the diaphragm to form a capacitor, may be housed in the internal space. A MEMS chip is weak against dust, however, the present structure in which anti-dust measures are taken is suitable for a microphone unit that uses a MEMS chip.

### Advantageous Effects of Invention

According to the present invention, it is an object of the present invention to provide a microphone unit that is able to prevent dust from invading during a transportation time, a mount process and the like and is unlikely to deteriorate in performance even if a reflow process is performed.

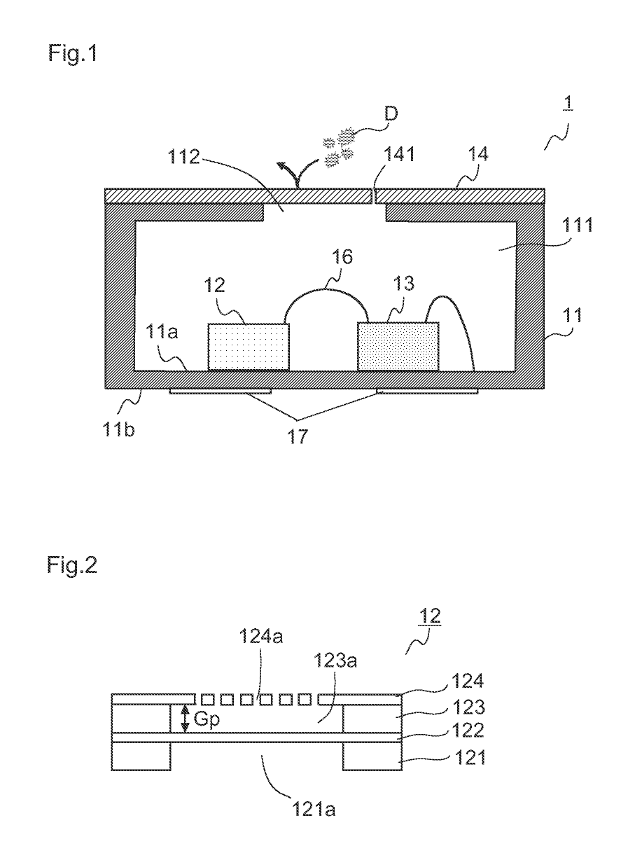

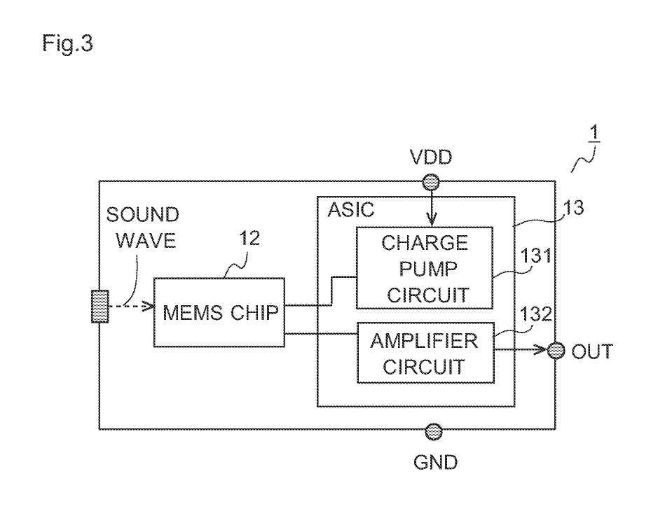

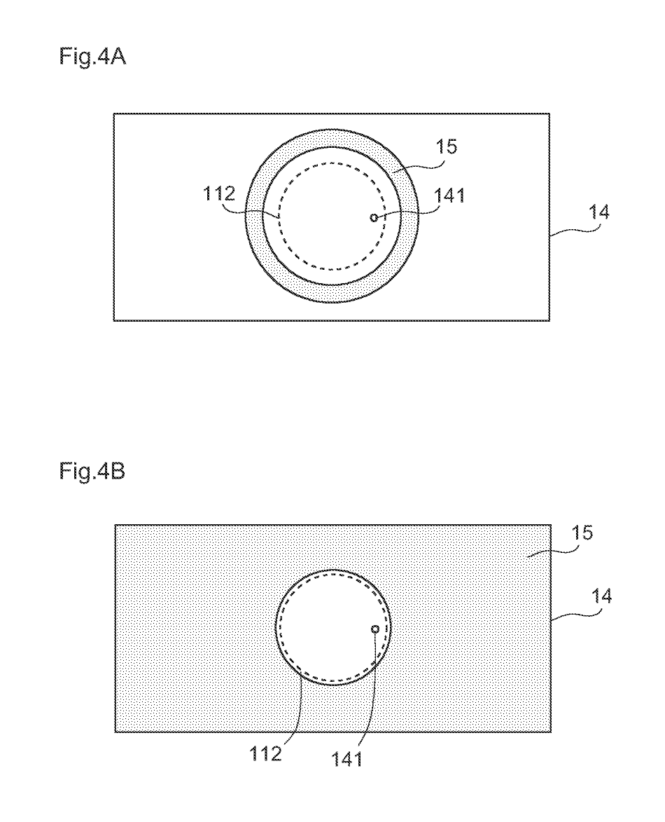

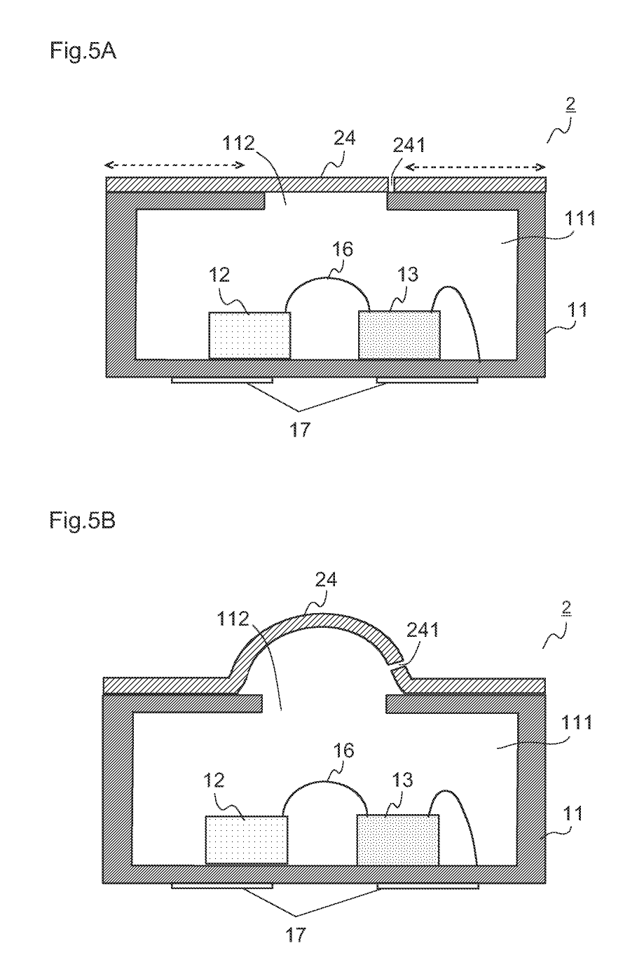

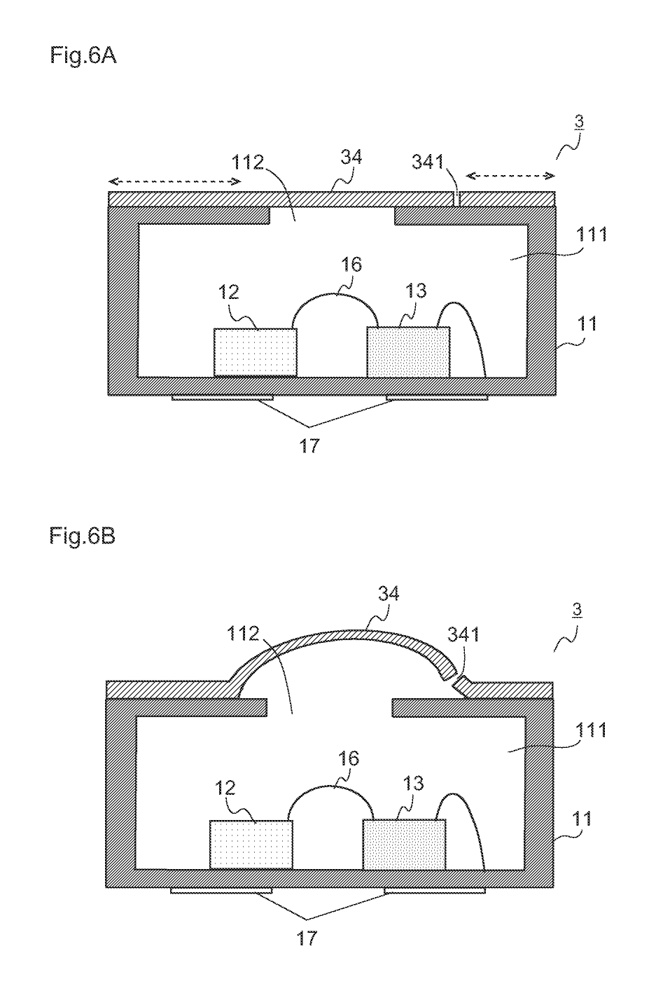

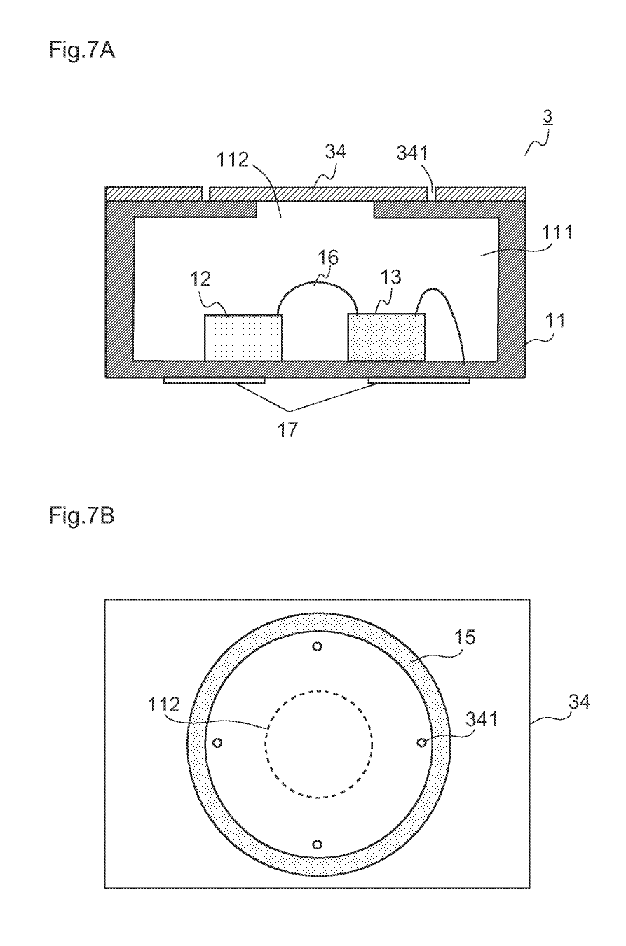

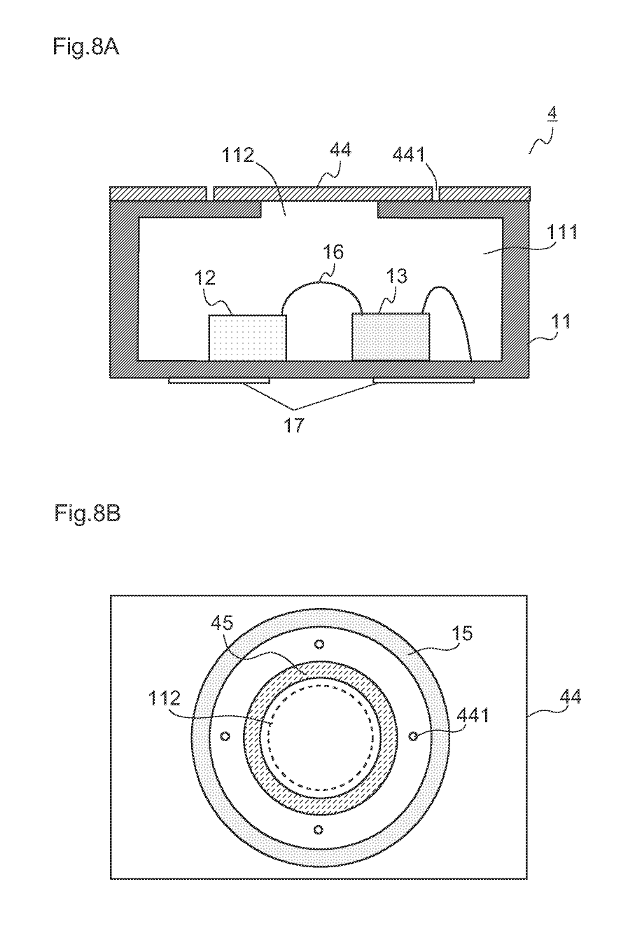

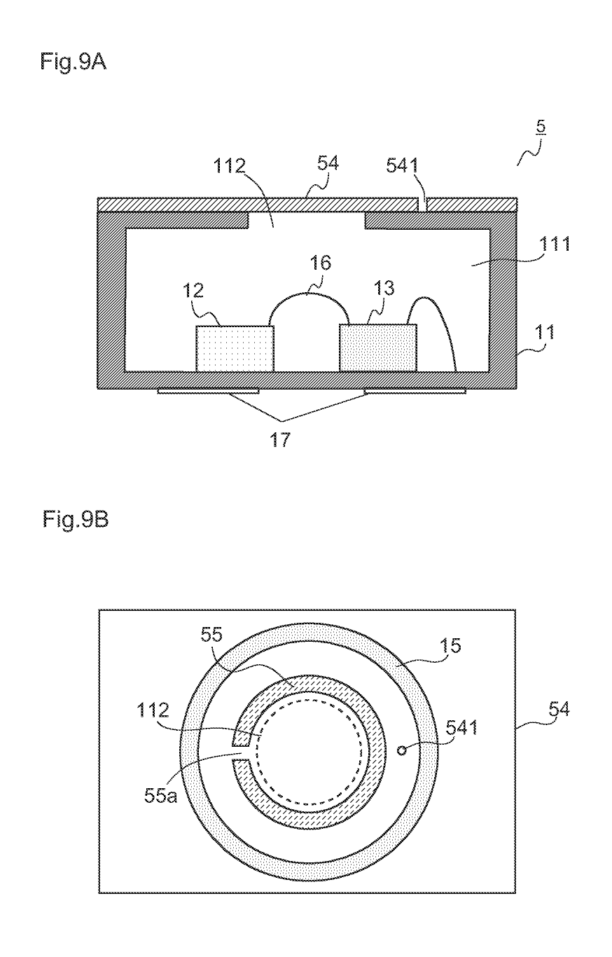

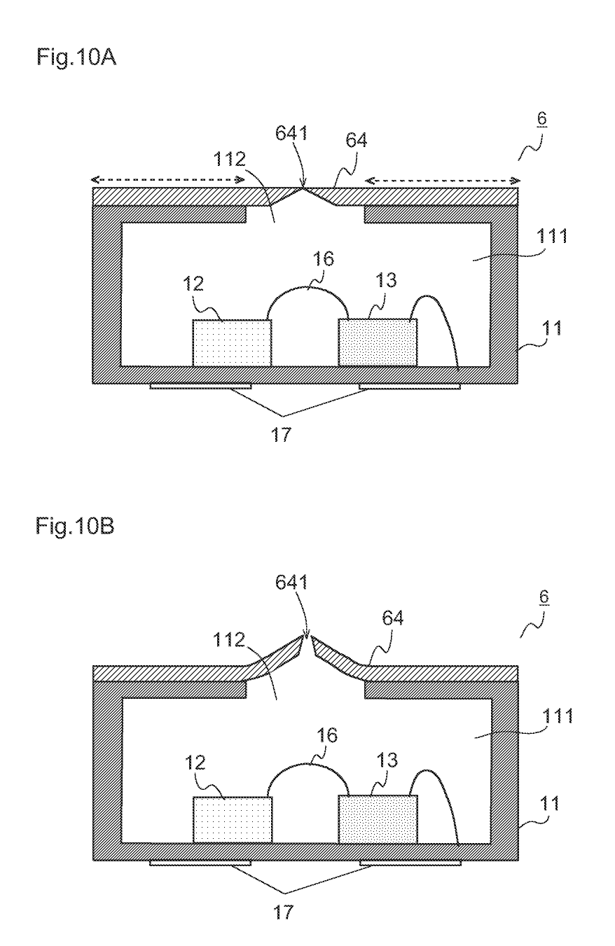

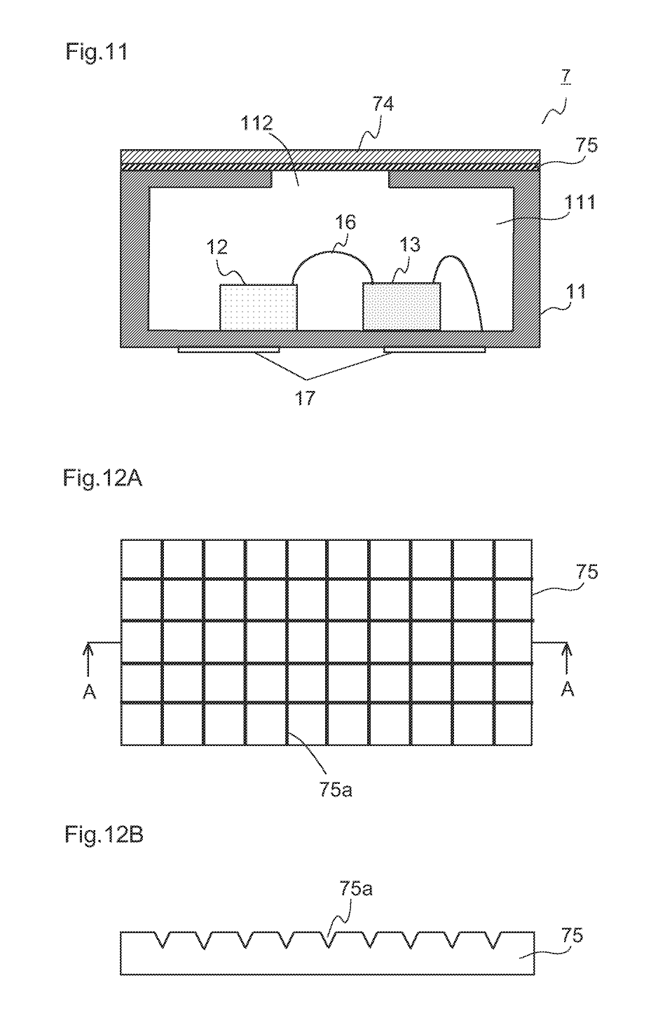

### BRIEF DESCRIPTION OF DRAWINGS

[FIG. 1] is a schematic sectional view showing a structure of a microphone unit according to a first embodiment to which the present invention is applied.

[FIG. 2] is a schematic sectional view showing a structure of a MEMS chip of the microphone unit according to the first embodiment.

[FIG. 3] is a block diagram showing a structure of the microphone unit according to the first embodiment.

[FIG. 4A] is a schematic view expecting a case where the microphone unit according to the first embodiment is viewed from a side (upper side) on which a film is disposed, that is, a view in a case where an adhesive portion is a first form.

[FIG. 4B] is a schematic view expecting a case where the microphone unit according to the first embodiment is viewed from a side (upper side) on which a film is disposed, that is, a view in a case where an adhesive portion is a second form.

[FIG. 5A] is a schematic sectional view showing a structure of a microphone unit according to a second embodiment to which the present invention is applied, that is, a view in a case where an internal pressure is equal to outside.

[FIG. 5B] is a schematic sectional view showing a structure of the microphone unit according to the second embodiment to which the present invention is applied, that is, a view in a case where an internal pressure rises.

[FIG. 6A] is a schematic sectional view showing a structure of a microphone unit according to a third embodiment to which the present invention is applied, that is, a view in a case where an internal pressure is equal to outside.

[FIG. 6B] is a schematic sectional view showing a structure of the microphone unit according to the third embodiment to which the present invention is applied, that is, a view in a case where an internal pressure rises.

[FIG. 7A] is a view showing a modification of the microphone unit according to the third embodiment, that is, a schematic sectional view of the microphone unit.

[FIG. 7B] is a view showing a modification of the microphone unit according to the third embodiment, that is, a schematic view expecting a case where the microphone unit is viewed from a side (upper side) on which a film is disposed.

[FIG. 8A] is a schematic sectional view of a microphone unit according to a fourth embodiment to which the present invention is applied.

[FIG. 8B] is a schematic view expecting a case where the microphone unit according to the fourth embodiment is viewed from a side (upper side) on which a film is disposed.

[FIG. 9A] is a schematic sectional view of a microphone unit according to a fifth embodiment to which the present invention is applied.

[FIG. 9B] is a schematic view expecting a case where the microphone unit according to the fifth embodiment is viewed from a side (upper side) on which a film is disposed.

[FIG. 10A] is a schematic sectional view showing a structure of a microphone unit according to a sixth embodiment to which the present invention is applied, that is, a view in a case where an internal pressure is equal to outside.

[FIG. 10B] is a schematic sectional view showing a structure of the microphone unit according to the sixth embodiment to which the present invention is applied, that is, a view in a case where an internal pressure rises.

[FIG. 11] is a schematic sectional view showing a structure of a microphone unit according to a seventh embodiment to which the present invention is applied.

[FIG. 12A] is a schematic plan view in a case where an adhesive layer of a film of the microphone unit according to the seventh embodiment is viewed from bottom.

[FIG. 12B] is a sectional view at an A-A position of FIG. 12A.

### DESCRIPTION OF EMBODIMENTS

Hereinafter, embodiments of a microphone unit to which the present invention is applied are described in detail with reference to the drawings. Here, a size, a thickness and the like of each member in the drawings are drawn aiming at easy understanding of the present invention and are not invariably drawn in accordance with an actual dimension. Besides, shapes of each member, a hole and the like are suitably modifiable without departing from the object of the present invention.

### First Embodiment

First, a microphone unit according to a first embodiment is described with reference to FIG. 1, FIG. 2, FIG. 3, FIG. 4A and FIG. 4B. FIG. 1 is a schematic sectional view showing a structure of the microphone unit according to the first embodiment to which the present invention is applied. FIG. 2 is a schematic sectional view showing a structure of a MEMS (Micro Electro Mechanical System) chip of the microphone unit according to the first embodiment. FIG. 3 is a block diagram showing a structure of the microphone unit according to the first embodiment. FIG. 4A and FIG. 4B are schematic views expecting a case where the microphone unit according to the first embodiment is viewed from a side (upper side) on which a film is disposed, that is, views showing a relationship among an internal pressure adjustment hole, an opening portion of a housing, and an adhesive portion (first adhesive portion). FIG. 4A is a view in a case where the adhesive portion is a first form, and FIG. 4B is a view in a case where the adhesive portion is a second form.

As shown in FIG. 1, the microphone unit 1 according to the first embodiment is composed to include: a housing 11; a MEMS chip 12; an ASIC (Application Specific Integrated Circuit) 13; and a film 14. Here, the film 14 is removed at a suitable timing after the microphone unit 1 is mounted in a mount target (e.g., a substrate included in apparatuses such as a mobile phone and the like which are disposed to process an input sound for a specific purpose. The same applies hereinafter.).

The housing 11 is formed, in its outer shape, into a substantially rectangular parallelepiped shape, and includes a space (internal space) 111 in which the MEMS chip 12 and the ASIC 13 are housed. Besides, an upper portion of the housing 11 is provided with an opening portion 112 that has a substantially circular shape when viewed from top, is used as a sound hole and guides a sound outside the housing 11 to the internal space 111. In the present embodiment, a structure is employed, in which the position of the opening portion 112 is disposed at a substantially central portion of the upper surface of the microphone unit 1, however, of course, the position of the opening portion 112 may be suitably changed.

The housing 11 is obtainable by, for example, placing (the bonded portion is sealed air-tightly) a cover, whose outer shape is a substantially rectangular parallelepiped shape and which has a concave space and an opening portion connecting to the concave portion, onto a substrate that has a substantially rectangular shape when viewed from top. In this case, as the substrate, it is possible to use, for example, a glass epoxy substrate, a polyimide substrate, a silicon substrate, a glass substrate and the like. The cover is able to be composed of, for example, a resin such as LCP (Liquid Crystal Polymer), PPS (polyphenylene sulfide) or the like. Here, to give electrical conductivity, a metal filler such as stainless steel or the like or a carbon may be mixed with the resin that composes the cover. Besides, the cover may be composed of a substrate material such as FR-4, ceramics or the like.

Here, the structure for forming the housing 11 is not limited to the above description, and, for example, a structure and the like may be employed, in which a flat plate-shaped cover (which has an opening portion) is placed on a box-shaped member.

The MEMS chip 12 housed in the internal space 111 of the housing 11 is composed of a silicon chip, and functions as an electro-acoustic conversion device that converts a sound signal into an electric signal based on vibration of a diaphragm. The MEMS chip 12 is a small capacitor type microphone chip that is produced by means of a semiconductor production technology, and its outer shape is a substantially rectangular parallelepiped shape. As shown in FIG. 2, the MEMS chip 12 includes: an insulating base substrate 121; a diaphragm 122; an insulating intermediate substrate 123; and a fixed electrode 124.

The base substrate 121 is provided with a through-hole 121a having a substantially circular shape when viewed from top through its central portion. The diaphragm 122 is a thin film that receives a sound pressure to vibrate (vibrates in a vertical direction of FIG. 2. Besides, in the present embodiment, a substantially circular portion vibrates), has electrical conductivity and forms one end of an electrode. The intermediate substrate 123 is disposed on the diaphragm 122, and like the base substrate 121, is provided with a through-hole 123a having a substantially circular shape when viewed from top through its central portion. The plate-shaped fixed electrode 124 disposed on the intermediate substrate 123 is provided with a plurality of small-diameter (about 10 μm in diameter) through-holes 124a. The diaphragm 122 and the fixed electrode 124, which are disposed to oppose each other and to be in a relationship parallel to each other over a gap Gp thanks to the presence of the intermediate substrate 133, form a capacitor.

When a sound wave comes and the diaphragm 122 vibrates, the capacitor formed of the fixed electrode 122 and the diaphragm 124 changes in between-electrodes distance, accordingly, changes in electrostatic capacity. As a result of this, it is possible to fetch the sound wave (sound signal), which enters the MEMS chip 12, as an electric signal. Here, in the MEMS chip 12, the upper surface of the diaphragm 122 communicates with an outside (outside the MEMS chip 12) space thanks to the presence of the plurality of the through-holes 124a formed through the fixed electrode 124. The structure of the MEMS chip 12 is not limited to the structure of the present embodiment, and the structure may be suitably modified.

The ASIC 13 is an integrated circuit that amplifies the electric signal that is fetched based on the change (caused by the vibration of the diaphragm 122) in the electrostatic capacity of the MEMS chip 12. As shown in FIG. 3, the ASIC 13 includes a charge pump circuit 131 that applies a bias voltage to the MEMS chip 12. The charge pump circuit 131 steps up a power supply voltage VDD and applies the bias voltage to the MEMS chip 12. Besides, the ASIC 13 includes an amplifier circuit 132 that detects the change in the electrostatic capacity of the MEMS chip 12. The electric signal amplified by the amplifier circuit 132 is output from the ASIC 13.

The MEMS chip 12 and the ASIC 13 are mounted on a bottom surface 11a (hereinafter, called a mount surface 11a) in the inside of the housing 11 by means of die bonding and wire bonding. In detail, the MEMS chip 12 is bonded by means of a not-shown die bonding material (e.g., an epoxy resin adhesive, a silicone resin adhesive and the like) such that a gap is not formed between its bottom surface and the mount surface 11a. According to this bonding, a trouble, in which a sound leaks inside from a gap formed between the mount surface 11a and the bottom surface of the MEMS chip 12, does not occur. Besides, the MEMS chip 12 is electrically connected to the ASIC 13 by means of a wire 16 (preferably a gold line).

In the ASIC 13, its bottom surface is bonded to the mount surface 11a by means of a not-shown die bonding material. The ASIC 13 is electrically connected, by means of the wire 16, to each of a plurality of not-shown electrode pads that are formed on the mount surface 11a. Each electrode pad is electrically connected, by means of a through-wiring, to a corresponding terminal of a plurality of external connection terminals 17 that are formed on the bottom surface 11b of the housing 11. The plurality of external connection terminals 17 include: a power supply terminal for inputting the power supply voltage (VDD); an output terminal that outputs the electric signal amplified by the amplifier circuit 132 of the ASIC 13; a GND terminal for ground connection. The external connection terminal 17 is electrically connected to an electrode terminal that is disposed on the mount substrate by means of a reflow process, whereby the microphone unit 1 becomes operable.

Here, in the present embodiment, the structure is employed, in which the MEMS chip 12 and the ASIC 13 are mounted by means of wire bonding; however, of course, the MEMS chip 12 and the AISC 13 may be mounted on the mount surface 11a by means of flip chip assembly.

The film 14 is disposed to aim at preventing dust D (see FIG. 1) from invading into the inside of the microphone unit 1 during a transportation time, a process of mounting the microphone unit 1 in a mount target and the like. The film 14 is formed of a material that has no air permeability, accordingly, a situation, in which dust occurs during an attachment time of the film 14 and the dust invades into the inside of the microphone unit 1, is unlikely to occur. For the film 14, it is preferable to select a single-layer material which does not emit dust from a film end surface when cutting it into pieces.

Besides, the film 14 is formed of a material that has heat resistance. This considers that the reflow process is performed in the case where the microphone unit 1 is mounted in the mount target. The reflow process is performed, for example, at a high temperature of about 260° C. in a case where a lead-free solder is used and performed at a high temperature of about 180° C. in a case where a eutectic solder is used. Accordingly, the film 14 is required to be resistant to the temperature that is used for the reflow process, and is preferable to be resistant to the temperatures of 180° C. or higher, further, preferable to be resistible to the temperatures of 260° C. or higher.

Besides, as it becomes clear in the following description, it is preferable that the film 14 has some flexibility, it is preferable that it is easy to apply an adhesive material, further, it is preferable that it is easy to form a hole. Considering these points, not especially limited though, in the present embodiment, as the film 14, a polyimide film is used. For example, in the case where a polyimide film is used, it is preferable that the thickness is formed to be 50 μm or smaller to secure the flexibility.

As described above, the film 14 is disposed such that the dust D does not invade from the opening portion 112 into the inside. Accordingly, the film 14 needs to be able to cover the opening portion 112, and in the present embodiment, is formed to have the substantially same size as the upper surface of the housing 11. Besides, it is preferable that the film 14 is bonded air-tightly to the housing 11 to surround the opening portion 112 such that the dust invasion prevention is ensured.

When bonding air-tightly the film 14 to the housing 11 to surround the opening portion 112, for example, as shown in FIG. 4A, a structure may be employed, in which an adhesive portion 15 (which corresponds to a first adhesive portion of the present invention) is disposed on a portion only around the opening portion 112. Besides, as another form, as shown in FIG. 4B, a structure may be employed, in which the adhesive portion 15 (which also corresponds to the first adhesive portion of the present invention) is disposed on not only the portion around the opening portion 112 but also the other portions.

In the example shown in FIG. 4A, in accordance with the shape of the opening portion 112, the adhesive portion 15 disposed on a lower surface of the film 14 is formed into a ring shape. Besides, in the example shown in FIG. 4B, a structure is employed, in which in the lower surface of the film 14, the adhesive portion 15 is disposed on the substantially entire portion other than the portion that faces the opening portion 112. Here, the film 14 is viewed from top, however, for the sake of description, FIG. 4A and FIG. 4B are drawn such that the adhesive portion 15 and the opening portion 112 are visible.

The film 14 is removed at a suitable timing after being mounted in the mount target. Because of this, it is preferable that the adhesive portion 15 is formed of a material whose adhesive force is lowerable when removing the film 14. For example, it is preferable that the adhesive portion 15 is formed of a material (referred to as a so-called heat peelable sheet and the like) whose adhesive force becomes low thanks to heating. And, it is preferable that the adhesive portion 15 is formed of a material whose adhesive force becomes low thanks to heat applied during a reflow time (of course, is required not to peel off even if an internal pressure is exerted during the reflow process time) and is easily peelable manually, for example, after the mounting of the microphone unit 1. As another example, the adhesive portion 15 may be formed of a material (referred to as a so-called ultraviolet curing adhesive material and the like) whose adhesive force becomes low thanks to ultraviolet irradiation.

Besides, as shown in FIG. 4A and FIG. 4B, the film 14 is provided with an internal pressure adjustment hole 141 (an example of an internal pressure adjustment portion of the present invention) that has a substantially circular shape when viewed from top and penetrates the film in a thickness direction. The internal pressure adjustment hole 141 is a small through-hole and formable by means of laser or the like. Besides, when viewing the microphone unit 1 from top (from a side on which the film 14 is formed), the internal pressure adjustment hole 141 is formed at a position that overlaps the opening portion 112.

In the case of mounting the microphone unit 1 in the mount target, the reflow process is performed as described above, and the microphone unit 1 is exposed to a high temperature (e.g., about 260° C.). In a case where the internal pressure adjustment hole 141 is not present, the internal pressure rises (about 1.8 fold) thanks to expansion of the air in the internal space of the microphone unit 1, and a large force acts on the film 14, whereby the film 14 or the adhesive portion 15 breaks. However, in the present embodiment, thanks to the presence of the internal pressure adjustment hole 141, the air in the internal space of the microphone unit 1 flows, and an internal pressure and an external pressure are equalizable to each other, accordingly, it is possible to prevent the film 4 and the adhesive portion 15 from breaking. In other words, in the microphone unit 1, it is possible to prevent the dust D from invading into the inside during the transportation time and the mount process by means of the film 14, further, in the microphone unit 1, it is possible to avoid a trouble in which the film 14 or the adhesive portion 15 breaks thanks to a rise of the internal pressure during the reflow process and a sharp pressure change acts on the diaphragm 122; as a result of this, the diaphragm 122 is excessively displaced and the film itself composing the diaphragm 122 breaks.

Generally, the diaphragm 122 used in the MEMS microphone is composed of a very thin film of about 1 μm of silicon (Si), for example, and susceptible to an overpressure. If a large pressure difference occurs between a front side and a rear side of the diaphragm 122, there is a case where the diaphragm 122 is excessively displaced to break. In the present embodiment, thanks to the presence of the internal pressure adjustment hole 141, the breakage of the film 14 or the adhesive portion 15 is avoidable, accordingly, it is possible to prevent the impact at the breakage time, that is, the sharp pressure change from acting on and breaking the diaphragm 122, and it is possible to avoid a situation as well in which the performance of the microphone unit 1 deteriorates after the reflow process.

Here, in the present embodiment, one internal pressure adjustment hole 141 is formed at the position that overlaps the opening portion 112 when viewing the microphone unit 1 from top; however, if necessary, a plurality of the internal pressure adjustment holes 141 may be disposed. The internal pressure of the microphone unit 1 during the reflow process is controllable by means of the area of the internal pressure adjustment hole 141. If the area of the internal pressure adjustment hole 141 is enlarged, the airflow amount passing through the internal pressure adjustment hole 141 increases, however, it becomes easy for the large dust D to invade into the inside of the microphone unit 1. On the other hand, by employing the structure in which a plurality of minuscule internal pressure adjustment holes 141, it is possible to prevent the invasion of the large dust D and to secure a total airflow amount.

Besides, in the case where the film 14 is provided with the hole, it is worried that the dust D invades from the hole. In this point, the internal pressure adjustment hole 141 is formed to have 100 μm or smaller, for example, accordingly, the invasion probability of the dust D is low. Besides, even if the dust D invades, the dust D is very small, accordingly, the likelihood that an operation defect of the MEMS chip 12 occurs thanks to the invasion of the dust D is very low.

Besides, it is conceived to provide the housing 11 with an internal pressure adjustment hole that alleviates the rise of the internal pressure during the reflow process time. However, this internal pressure adjustment hole causes an acoustic leak which deteriorates an acoustic characteristic of the microphone unit 1. Especially, the acoustic leak from the housing 11 deteriorates sensitivity in a low frequency band of a frequency characteristic of the microphone, accordingly, it is not preferable to provide the housing 11 with an internal pressure adjustment hole. Because of this, in the present embodiment, the structure is employed, in which the film 14 removed later is provided with the internal pressure adjustment hole 141.

### Second Embodiment

Next, a microphone unit according to a second embodiment is described with reference to FIG. 5A and FIG. 5B. FIG. 5A and FIG. 5B are schematic sectional views showing a structure of the microphone unit according to the second embodiment to which the present invention is applied. FIG. 5A shows a state of a case where the internal pressure is equal to the outside, and FIG. 5B shows a state of a case where the internal pressure rises.

The microphone unit 2 according to the second embodiment has the same structure as the microphone unit 1 according to the first embodiment except for a structure of a film 24. Because of this, portions overlapping the first embodiment are indicated by the same reference numbers and description of them is skipped, and hereinafter, the description is performed focusing on different portions as far as it is possible.

The film 24 of the microphone unit 2 also is composed of a material that has the same properties as the first embodiment. In other words, the film 24 also is formed of a material that has no air permeability and has heat resistance. Specifically, like the film 14 according to the first embodiment, the film 24 is composed of a polyimide film. Besides, like the first embodiment, the film 24 has the substantially same size as the upper surface of the housing 11. Besides, to ensure the dust invasion prevention, the film 24 is air-tightly bonded to the housing 11 to surround the opening portion 112.

Here, an adhesive portion (first adhesive portion of the present invention) for air-tightly bonding the film 24 to the housing 11 is disposed in a region indicated by a broken line arrow in FIG. 5A. In other word, like the case of FIG. 4B, the structure is employed, in which the adhesive portion is disposed on not only the portion around the opening portion 112 but also the other portions. However, as described in detail later, the position of an internal pressure adjustment hole 241 disposed through the film 24 is different from the position where the internal pressure adjustment hole 141 according to the first embodiment is disposed, accordingly, the region where the adhesive portion is disposed is not completely the same as FIG. 4B. Besides, the region shown in FIG. 5A where the adhesive portion is disposed is an example, and if the adhesive portion is disposed to surround the opening portion 112 and is disposed at a more outer position than the internal pressure adjustment hole 241, other structures such as a ring shape and the like may be employed.

Like the case of the first embodiment, the internal pressure adjustment hole 241 disposed through the film 24 is a small through-hole that has a substantially circular shape when viewed from top and penetrates the film 24 in a thickness direction. Unlike the case of the first embodiment, when viewing the microphone unit 2 from top (from a side on which the film 24 is disposed), the internal pressure adjustment hole 241 is disposed at a position that does not overlap the opening portion 112. In more detail, the internal pressure adjustment hole 241 is disposed at a position (near the opening portion 112) that is slightly deviated outward from an end surface of the opening portion 112. Here, when viewing the microphone unit 2 from top, the internal pressure adjustment hole 241 is disposed at a more inner position than the adhesive portion.

Also in the case where the film 24 is disposed as described above, it is possible to prevent the dust D from invading into the inside of the microphone unit 2 during the transportation time and the time of mounting in the mount target. Especially, when viewing the microphone unit 2 from top, the internal pressure adjustment hole 241 is situated at the position that does not overlap the opening portion 112, accordingly, even if the dust D invades from the internal pressure adjustment hole 241 (which easily occurs in a case where air is sucked into the inside thanks to a decline in the internal pressure), the invasion of the dust D into the inside is discouraged by the housing 11 and the film 24. Because of this, the microphone unit 2 has the structure which is able to lower the invasion probability of the dust D compared with the case of the first embodiment.

Besides, if the internal pressure of the microphone unit 2 rises during the reflow process, the film 24 is lifted (see FIG. 5B). According to this, the internal pressure adjustment hole 241 and the opening portion 112 communicate with each other, and the internal pressure and the external pressure of the microphone unit 1 are equalizable to each other, accordingly, the internal pressure does not rise higher than necessary, and the film 24 or the adhesive portion 15 does not break during the reflow process. Here, the internal pressure adjustment hole 241 is disposed near the opening portion 112, accordingly, it is easy to obtain the structure in which the internal pressure adjustment hole 241 and the opening portion 112 communicate with each other thanks to the rise of the internal pressure.

Besides, in the present embodiment, when viewing the microphone unit 2 from top, one internal pressure adjustment hole 241 is disposed at the position that does not overlap the opening portion 112 and is near the opening portion 112, however, if necessary, a plurality of the internal pressure adjustment holes may be disposed.

### Third Embodiment

Next, a microphone unit according to a third embodiment is described with reference to FIG. 6A and FIG. 6B. FIG. 6A and FIG. 6B are schematic sectional views showing a structure of the microphone unit according to the third embodiment to which the present invention is applied, FIG. 6A shows a state of a case where the internal pressure is equal to the outside, and FIG. 6B shows a state of a case where the internal pressure rises.

The microphone unit 3 according to the third embodiment has the same structure as the microphone units 1, 2 according to the first and second embodiments except for a structure of a film 34. Because of this, portions overlapping the first and second embodiments are indicated by the same reference numbers and description of them is skipped, and hereinafter, the description is performed focusing on different portions as far as it is possible.

The microphone unit 3 according to the third embodiment has the substantially same structure as the microphone unit 2 according to the second embodiment, and only the position of an internal pressure adjustment hole 341 disposed through the film 34 and the region (indicated by a broken line arrow in FIG. 6A) where an adhesive portion (first adhesive portion of the present invention) is disposed are different. The difference between the regions where the adhesive portion is disposed is due to the different positions of the internal pressure adjustment holes 341.

In detail, when viewing the microphone unit 3 from top (from a side on which the film 34 is disposed), like the second embodiment, the internal pressure adjustment hole 341 is disposed at a position that does not overlap the opening portion 112. However, the internal pressure adjustment hole 341 is not disposed near the opening portion 112 but at a position away outward from the end surface of the opening portion 112.

Also in the case where the film 34 is disposed as described above, it is possible to prevent the dust D from invading into the inside of the microphone unit 3 during the transportation time and the time of mounting in the mount target. And, like the case of the second embodiment, even if the dust D invades into the internal pressure adjustment hole 341, the invasion of the dust D into the inside is discouraged by the housing 11 and the film 34, accordingly, it is possible to lower the probability of the invasion of the dust D into the inside of the microphone unit 3. Especially, the distance from the internal pressure adjustment hole 341 to the opening portion 112 is long compared with the case of the second embodiment, accordingly, it is possible to lessen the invasion of the dust D into the inside at a higher probability.

Besides, if the internal pressure of the microphone unit 3 rises during the reflow process, the film 34 is lifted (see FIG. 6B). According to this, the internal pressure adjustment hole 341 and the opening portion 112 communicate with each other, accordingly, the internal pressure does not rise higher than necessary and the film 34 or the adhesive portion 15 does not break during the reflow process.

Besides, in the present embodiment, when viewing the microphone unit 3 from top, one internal pressure adjustment hole 341 is disposed at the position that does not overlap the opening portion 112 and is away from the opening portion 112. However, this structure is not limiting, and for example, a plurality of the internal pressure adjustment holes 341 (four in FIG. 7A and FIG. 7B) may be disposed as shown in FIG. 7A and FIG. 7B.

FIG. 7A and FIG. 7B are views showing a modification of the microphone unit according to the third embodiment. FIG. 7A is a schematic sectional view of the microphone unit 3 according to the modification. Besides, FIG. 7B is a schematic view expecting a case where the microphone unit 3 according to the modification is viewed from the side (upper side) on which the film 34 is disposed, that is, a view showing a relationship among the internal pressure adjustment hole 341, the opening portion 112 of the housing, and the adhesive portion 15 (first adhesive portion). Here, the film 34 is viewed from top, however, for the sake of description, FIG. 7B is drawn such that the adhesive portion 15 and the opening portion 112 are visible.

In the microphone unit 3 according to the modification, the adhesive portion 15 is formed into a ring shape, however, the structure of the adhesive portion 15 is not limited to this. In other words, if the adhesive portion 15 is disposed to surround the opening portion 112 and is disposed at a more outer position than the internal pressure adjustment hole 341, other structures (e.g., a structure and the like in which the adhesive portion is disposed on the ring-shaped portion of FIG. 7B and the entire outer portion of the ring-shaped portion) maybe employed.

### Fourth Embodiment

Next, a microphone unit according to a fourth embodiment is described with reference to FIG. 8A and FIG. 8B. FIG. 8A and FIG. 8B are views showing a structure of the microphone unit according to the fourth embodiment to which the present invention is applied, FIG. 8A is a schematic sectional view of the microphone unit according to the fourth embodiment, and FIG. 8B is a schematic view expecting a case where the microphone unit according to the fourth embodiment is viewed from a side (upper side) on which a film is disposed.

The microphone unit 4 according to the fourth embodiment has the same structure as the microphone units 1 to 3 according to the first to third embodiments except for a structure of a film 44. Because of this, portions overlapping these embodiments are indicated by the same reference numbers and description of them is skipped, hereinafter, the description is performed focusing on different portions as far as it is possible.

The microphone unit 4 according to the fourth embodiment has the substantially same structure as the microphone unit 3 according to the modification of the third embodiment (see FIG. 7A and FIG. 7B), and only the structure for bonding the film 44 to the housing 11 is different. In the microphone unit 4 according to the fourth embodiment, when viewing the microphone unit 4 from top (from a side on which the film 44 is disposed), by means of the ring-shaped adhesive portion 15 (first adhesive portion) that is disposed to surround the opening portion 112 and disposed at a more outer position than an internal pressure adjustment hole 441, the film 44 is air-tightly bonded to the housing 11 (see FIG. 8B). This point is the same as the microphone unit 3 according to the modification of the third embodiment.

However, the structure is different from the structure of the microphone unit 3 according to the modification of the second embodiment in that a ring-shaped second adhesive portion 45 is further disposed between the opening portion 112 and the internal pressure adjustment hole 441 to surround the opening portion 112 (see FIG. 8B). The second adhesive portion 45 bonds air-tightly the film 44 and the housing 11 to each other by means of an adhesive force weaker than the first adhesive portion 15. Here, the film 44 is viewed from top, however, for the sake of description, FIG. 8B is drawn such that the first adhesive portion 15, the second adhesive portion 45 and the opening portion 112 are visible.

The adhesive force of the second adhesive portion 45 is set such that if the internal pressure of the microphone unit 4 rises and a force exceeding a predetermined pressure (which is set at a low value such that the film 44 does not break) acts on the film 44, the film 44 easily peels off. Here, the adhesive force of the first adhesive portion 15 is set such that even if the internal pressure of the microphone unit 4 rises and a pressure acts on the film 44, the film 44 does not easily peel off. Here, as methods for lowering the adhesive force of the second adhesive portion 45 than the adhesive force of the first adhesive portion 15, there are methods such as a method for changing the adhesive force itself, a method for changing a ring width and the like. In a case where the same adhesive is used for the first adhesive portion 15 and the second adhesive portion 45, it is sufficient to perform the forming such that the ring width of the second adhesive portion 45 becomes narrower than the ring width of the first adhesive portion 15.

Also in the microphone unit 4 composed as described above, it is possible to prevent, by means of the film 44, the dust D from invading into the inside during the transportation time and the time of mounting in the mount target. And, the second adhesive portion 45 is disposed at a more inner portion than the internal pressure adjustment hole 441, accordingly, it is easy to avoid a trouble in which the dust D invades into the inside via the internal pressure adjustment hole 441. Besides, the internal pressure adjustment hole 441 is disposed at a position away from the opening portion 112, accordingly, even if the second adhesive portion 45 having the weak adhesive force peels off, like the case of the third embodiment, it is possible to lower the probability of the invasion of the dust D into the inside of the microphone unit 4.

Besides, if the internal pressure of the microphone unit 4 rises during the reflow process, the housing 11 and the film 44 bonded to each other by means of the second adhesive portion 45 having the weak adhesive force are peeled from each other. According to this, like the case of FIG. 6B, the more inner portion of the film 44 than the first adhesive portion 15 is lifted, the internal pressure adjustment hole 441 and the opening portion 112 communicate with each other, and the internal pressure of the microphone unit 1 and the external pressure are equalizable to each other. According to this, the internal pressure does not rise higher than necessary, and the film 44 or the adhesive portion 15 does not break during the reflow process.

Here, in the present embodiment, the number of the internal adjustment holes is plural (specifically, four), however, the number of the internal pressure adjustment holes may be one. Besides, in the case of viewing the microphone unit 4 from top (from a side on which the film 44 is disposed), it is sufficient that the disposition region of the second adhesive portion 45 disposed to surround the opening portion 112 spreads outward from a position more inner than the internal pressure adjustment hole 441 between the opening portion 112 and the first adhesive portion 15, and the region is suitably modifiable. For example, in FIG. 8B, a structure may be employed, in which the region of the second adhesive portion 45 spreads to a boundary of the first adhesive portion 15. In the case of this structure, it is necessary that the second adhesive portion 45 does not close the internal pressure adjustment hole 441.

Besides, the first adhesive portion 15 is formed into the ring shape, however, the structure of the first adhesive portion 15 is not limited to this. In other words, if the first adhesive portion 15 is disposed to surround the opening portion 112 and is disposed at a more outer position than the internal pressure adjustment hole 441, other structures (e.g., a structure and the like in which the adhesive portion is disposed on the ring-shaped portion of FIG. 8B and the entire outer portion of the ring-shaped portion) maybe employed.

### Fifth Embodiment

Next, a microphone unit according to a fifth embodiment is described with reference to FIG. 9A and FIG. 9B. FIG. 9A and FIG. 9B are views showing a structure of the microphone unit according to the fifth embodiment to which the present invention is applied, FIG. 9A is a schematic sectional view of the microphone unit according to the fifth embodiment, and FIG. 9B is a schematic view expecting a case where the microphone unit according to the fifth embodiment is viewed from a side (upper side) on which a film is disposed.

The microphone unit 5 according to the fifth embodiment has the same structure as the microphone units 1 to 4 according to the first to fourth embodiments except for a structure of a film 54. Because of this, portions overlapping these embodiments are indicated by the same reference numbers and description of them is skipped, hereinafter, the description is performed focusing on different portions as far as it is possible.

In the microphone unit 5 according to the fifth embodiment, when viewing the microphone unit 5 from top (from a side on which the film 54 is disposed), like the microphone unit 3 according to the third embodiment, an internal pressure adjustment hole 541 is disposed at a position that does not overlap the opening portion 112 and is away from the opening portion 112. However, the structure for mounting the film 54 on the housing 11 is different from the case of the third embodiment.

As shown in FIG. 9B, when viewing the microphone unit 5 from top, by means of the ring-shaped adhesive portion 15 (first adhesive portion) that is disposed to surround the opening portion 112 and disposed at a more outer position than an internal pressure adjustment hole 541, the film 54 is air-tightly bonded to the housing 11. Besides, a ring-shaped second adhesive portion 55 is disposed between the opening portion 112 and the internal pressure adjustment hole 541 to surround the opening portion 112 except for a portion. The first adhesive portion 15 and the second adhesive portion 55 have the same adhesive force.

Here, the film 54 is viewed from top, however, for the sake of description, FIG. 9B is drawn such that the first adhesive portion 15, the second adhesive portion 55 and the opening portion 112 are visible.

The ring-shaped second adhesive portion 55 is provided with an opening 55a through a portion. The internal pressure adjustment hole 541 is disposed at a position as distant from the opening 55a disposed through the second adhesive portion 55 as possible. Specifically, the internal pressure adjustment hole 541 is disposed near a position opposite the position where the opening 55a of the second adhesive portion 55 is disposed with the opening portion 112 interposed.

Also in the microphone unit 5 composed as described above, it is possible to prevent, by means of the film 54, the dust D from invading into the inside during the transportation time and the time of mounting in the mount target. And, the second adhesive portion 55 provided with the opening 55a is disposed, whereby it is possible to lengthen the actual distance between the opening 112 and the internal pressure adjustment hole 541 longer than the case of the third embodiment. Because of this, it is possible to lower the probability of the invasion of the dust D into the inside of the microphone unit 5.

Besides, if the internal pressure of the microphone unit 5 rises during the reflow process, a portion between the first adhesive portion 15 and the second adhesive portion 55 is lifted, and the internal pressure adjustment hole 541 and the opening portion 112 communicate with each other. Because of this, the internal pressure in the inside of the microphone unit 5 does not rise higher than necessary, and the film 54 or the adhesive portions 15, 55 do not break during the reflow process.

Here, in the present embodiment, the number of the internal adjustment holes 541 is one, however, the number may be plural. Also in this case, it is preferable that each internal pressure adjustment hole 541 is disposed at a position as distant from the opening 55a as possible. Besides, the first adhesive portion 15 is formed into the ring shape, however, the structure of the first adhesive portion 15 is not limited to this. In other words, if the first adhesive portion 15 is disposed to surround the opening portion 112 and is disposed at a more outer position than the internal pressure adjustment hole 541, other structures (e.g., a structure and the like in which the adhesive portion is disposed on the ring-shaped portion of FIG. 9B and the entire outer portion of the ring-shaped portion) maybe employed.

### Sixth Embodiment

Next, a microphone unit according to a sixth embodiment is described with reference to FIG. 10A and FIG. 10B. FIG. 10A and FIG. 10B are schematic sectional views that show a structure of the microphone unit according to the sixth embodiment to which the present invention is applied, FIG. 10A shows a state of a case where the internal pressure is equal to the outside, and FIG. 10B shows a state of a case where the internal pressure rises.

The microphone unit 6 according to the sixth embodiment has the same structure as the microphone units 1 to 5 according to the first to fifth embodiments except for a structure of a film 64. Because of this, portions overlapping these embodiments are indicated by the same reference numbers and description of them is skipped, hereinafter, the description is performed focusing on different portions as far as it is possible.

The film 64 of the microphone unit 6 also is composed of a material that has the same properties as the first embodiment and the like. In other words, the film 64 also is formed of a material that has no air permeability and has heat resistance, specifically, the film 64 is composed of a polyimide film. Besides, like the first embodiment and the like, the film 64 has the substantially same size as the upper surface of the housing 11. Besides, to ensure the dust invasion prevention, the film 64 is air-tightly bonded to the housing 11 to surround the opening portion 112.

Here, a structure is employed, in which the adhesive portion (first adhesive portion of the present invention) for air-tightly bonding the film 64 to the housing 11 is disposed in a region indicated by a broken line arrow in FIG. 10A, that is, like the case of FIG. 4B, disposed on not only the portion around the opening portion 112 but also the other portions. Besides, the region shown in FIG. 10A where the adhesive portion is disposed is an example, and if the adhesive portion is disposed to surround the opening portion 112 and is disposed at a more outer position than an internal pressure adjustment portion 641, other structures such as a ring shape and the like may be employed.

When viewing the microphone unit 6 from top (from a side on which the film 64 is formed), the internal pressure adjustment portion 641 is formed at a position (in more detail, the substantially central portion of the film 64) that overlaps the opening portion 112. The internal pressure adjustment portion 641 is a thin portion that is obtained by thinning a portion of the film 64 by means of laser or the like, for example. The thin portion 641 is disposed to easily break in a case where a small pressure acts on the film 64. Besides, the size of the thin portion 641 is formed small such that an opening diameter of an through-hole formed at the breakage becomes small. Here, it is preferable that the opening diameter of the through-hole, which is formed when the thin portion 641 breaks, is 100 μm or smaller. Besides, the thin portion 641 of the film 64 may be obtained by melting a portion of the film 64 by means of a chemical or the like.

Also in the case where the microphone unit 6 is disposed as described above, it is possible to prevent the dust D from invading into the inside of the microphone unit 6 during the transportation time and the time of mounting in the mount target. Especially, the internal pressure adjustment portion 641 of the film 64 is not a through-hole, but in a closed state in principle, accordingly, like the first embodiment, compared with the case where the internal pressure adjustment hole 141 is disposed, it is possible to reduce the likelihood that dust D invades into the inside of the microphone unit 6.

Besides, if the internal pressure of the microphone unit 6 rises during the reflow process, a force acts on the film 64 and the internal pressure adjustment portion (thin portion) 641 easily breaks as shown in FIG. 10B. The internal pressure adjustment portion 641 easily breaks, accordingly, unlike a structure in which the internal pressure adjustment portion 641 is not disposed, there is not a large impact when the internal pressure rises to break the film, and the likelihood that the operation defect occurs in the MEMS chip 12 is low. And, the opening diameter of the hole becomes small in the case where the thin portion 641 breaks, accordingly, even after the thin portion 641 breaks, it is hard for the dust D to invade into the inside of the microphone unit 6.

Here, in the present embodiment, the structure is employed, in which when viewing the microphone unit 6 from top, the internal pressure adjustment portion (thin portion) 641 is formed at the position that overlaps the opening portion 112, however, when necessary, the internal pressure adjustment portion may be disposed at a position that does not overlap the opening portion 112.

### Seventh Embodiment

Next, a microphone unit according to a seventh embodiment is described with reference to FIG. 11, FIG. 12A and FIG. 12B. FIG. 11 is a schematic sectional view showing a structure of the microphone unit according to the seventh embodiment to which the present invention is applied. FIG. 12A and FIG. 12B are views that show a structure of an adhesive layer of a film of the microphone unit according to the seventh embodiment, FIG. 12A is a schematic plan view in a case where the adhesive layer is viewed from bottom, and FIG. 12B is a sectional view at an A-A position of FIG. 12A.

The microphone unit 7 according to the seventh embodiment has the same structure as the microphone units 1 to 6 according to the first to sixth embodiments except for a structure of a film 74. Because of this, portions overlapping these embodiments are indicated by the same reference numbers and description of them is skipped, hereinafter, the description is performed focusing on different portions as far as it is possible.

The film 74 also is formed of a material that has no air permeability and has heat resistance, and is composed of a polyimide film, for example. The film 74 has the substantially same size as the upper surface of the housing 11. An adhesive layer 75 is disposed on an entire lower surface (surface that opposes the housing 11) of the film 74. A concave and a convex are formed on a surface of the adhesive layer 75, which opposes the surface where the film 74 is present, by means of, for example, grooving, embossing and the like (besides, laser machining and the like may be used). In FIG. 12A, a portion indicated by a thick solid line corresponds to a concave portion 75a.

In the microphone unit 7, the concave portion 75a is formed into a lattice shape, and both ends of any concave portion 75a extend to end portions of the adhesive layer 75. In other words, in a state where the film 74 is attached to the housing 11, the inside of the housing 11 is in a state to communicate with the outside by means of the opening portion 112 and the concave portion 75a of the adhesive layer 75.

Also in the microphone unit 7 composed as described above, it is possible to prevent the dust D from invading into the inside during the transportation time and the time of mounting in the mount target. Here, in the microphone unit 7, there is a likelihood that the dust D invades into the concave portion 75a of the adhesive layer 75 from its side surface. However, it is highly likely that the dust D adheres to the adhesive layer 75 before reaching the inside of the microphone unit 7, and most of the dust does not reach the inside of the microphone unit 7. Because of this, it is possible to lower the probability of the invasion of the dust D into the inside of the microphone unit 7.

Besides, in the present embodiment, thanks to the presence of the concave portion 75a of the adhesive layer 75, the internal pressure of the microphone unit 7 and the external pressure are equalizable to each other, accordingly, it is possible to prevent the film 74 or the adhesive layer 75 from breaking during the reflow process. In other words, in the microphone unit 7, the concave portion 75a formed on the adhesive layer 75 functions as the internal pressure adjustment portion. Here, it is preferable to set the height of the concave portion 75a at 50 μm or higher to 500 μm or lower.

Here, in the present embodiment, the structure is employed, in which the checker-shaped concave portion 75a is disposed on the adhesive layer 75, however, this structure is not limiting. In other words, for example, a structure and the like may be employed, in which the adhesive layer 75 is provided with at least one concave portion that simply extends in a vertical direction, a horizontal direction, or in an oblique direction.

Besides, in the present embodiment, the structure is employed, in which the checker-shaped concave portion 75a is disposed on the adhesive layer 75, however, a structure may be employed, in which by disposing a concave and a convex on the film 74 without disposing the concave portion on the adhesive portion 75, the concave and convex of the film 74 are transferred onto the adhesive layer 75.

(Others)

The embodiments described above indicate application examples of the present invention, and the application scope of the present invention is not limited to the embodiments described above. In other words, various modifications may be added to the above embodiments without departing from the object of the present invention.

For example, in the embodiments described above, the MEMS chip 12 and the ASIC 13 are composed of chips separate from each other; however, the integrated circuit mounted on the ASIC 13 may be monolithically formed on the silicon substrate that forms the MEMS chip 12.

Besides, in the embodiments described above, the case is described, where the present invention is applied to the structure in which the MEMS chip 12 formed by means of the semiconductor production technology is housed in the housing 11. However, the application scope of the present invention is not limited to this structure. In other words, for example, the present invention is applicable to a capacitor type microphone unit and the like that use an electret film.

Further, the present invention is also applicable to a microphone unit that employs a structure other than the capacitor type microphone, for example, the present invention is applicable to a microphone unit which employs a moving conductor (dynamic) type microphone, an electromagnetic (magnetic) type microphone, a piezo-electric type microphone and the like.

### INDUSTRIAL APPLICABILITY

The microphone unit according to the present invention is suitable to, for example, voice communication apparatuses such as a mobile phone, a transceiver and the like, voice process systems (voice identification system, voice recognition system, command generation system, electronic dictionary, translation apparatus, remote controller of voice input type and the like) that use a technology for analyzing an input voice, or to recording apparatuses and amplifier systems (loud speakers), mike systems and the like.

### REFERENCE SIGNS LIST

1, 2, 3, 4, 5, 6, 7 microphone units
11 housing
14, 24, 34, 44, 54, 64, 74 films
15 adhesive portion (first adhesive portion)
45, 55 second adhesive portions
75 adhesive layer
75a concave portion
111 internal space
112 opening portion
122 diaphragm
124 fixed electrode
141, 241, 341, 441, 541 internal pressure adjustment holes
641 thin portion (internal pressure adjustment portion)

1. A microphone unit comprising:
a diaphragm that is vibrated by a sound pressure;
a housing that is provided with an internal space for housing the diaphragm and an opening portion which is used as a sound hole and makes the internal space communicate with the outside; and
a film that is formed of a material having no air permeability and that is bonded to the housing to cover the opening portion; wherein
the film is provided with an internal pressure adjustment portion.

2. The microphone unit according to claim 1, wherein
the film is bonded to the housing by a first adhesive portion that is formed to surround the opening portion; and
when viewing the microphone unit from a side on which the film is disposed, the internal pressure adjustment portion is disposed at a more inner position than the first adhesive portion.

3. The microphone unit according to claim 2, wherein
the internal pressure adjustment portion comprises at least one internal pressure adjustment hole that penetrates the film.

4. The microphone unit according to claim 3, wherein
when viewing the microphone unit from the side on which the film is disposed, the internal pressure adjustment hole is disposed at a position that overlaps the opening portion.

5. The microphone unit according to claim 3, wherein
when viewing the microphone unit from the side on which the film is disposed, the internal pressure adjustment hole is disposed at a position that does not overlap the opening portion.

6. The microphone unit according to claim 5, wherein
the internal pressure adjustment hole is disposed near the opening portion.

7. The microphone unit according to claim 5, wherein
the internal pressure adjustment hole is disposed at a more outer distant position than the opening portion.

8. The microphone unit according to claim 7, wherein
when viewing the microphone unit from the side on which the film is disposed, a second adhesive portion is disposed to spread outward, from a position more inner than the internal pressure adjustment hole, between the opening portion and the first adhesive portion to surround the opening portion, and bonds the film and the housing to each other by means of an adhesive force weaker than the first adhesive portion.

9. The microphone unit according to claim 7, wherein
when viewing the microphone unit from the side on which the film is disposed, a second adhesive portion is disposed between the opening portion and the first adhesive portion to surround the opening portion except for an open portion of the first adhesive portion, and bonds the film and the housing to each other, the internal pressure adjustment hole being disposed at a position that is between the first adhesive portion and the second adhesive portion and is away from the open portion of the first adhesive portion.

10. The microphone unit according to claim 2, wherein
the internal pressure adjustment portion is a thin portion that changes into a minuscule through-hole in a case where a pressure acts on the film.

11. The microphone unit according to claim 2, wherein
one surface of the film is provided with an adhesive layer that has a concave and convex shape, and a concave portion formed on the adhesive layer functions as the internal pressure adjustment portion.

12. The microphone unit according to claim 1, wherein
a MEMS (Micro Electro Mechanical System) chip comprising the diaphragm and a fixed electrode that collaborates with the diaphragm to form a capacitor is housed in the internal space.
